(19) United States
(12) Patent Application Publication
(10) Pub. No.: US 2006/0245334 A1
(43) Pub. Date: Nov. 2, 2006

(54) Optical head and optical disc apparatus

(76) Inventors: Kazuhiro Nagata, Yokohama-shi (JP); Katsuo Iwata, Yokohama-shi (JP); Yuuichi Nakamura, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/410,069

(22) Filed: Apr. 25, 2006

(30) Foreign Application Priority Data
Apr. 27, 2005 (JP) 2005-129855

(51) Int. Cl. G11B 7/135

(52) U.S. Cl. 369/112.28

(57) ABSTRACT

To have laser light sources with different wavelengths as one body, to guide the optical axes of the laser light sources through a common optics as far as possible, and to realize compactness, manufacturing easiness, low cost and high performance and reliability, when the wavelengths of laser beams from first, second and third light sources 21, 22, and 23 are different, a laser beam with a shortest wavelength is output from the first light source, a laser beam with a intermediate wavelength is output from the second light source, and a laser beam with a longest wavelength is output from the third light source. In this arrangement, a laser beam from the light source with a shortest wavelength is reflected by the least number of times.

### CROSS-REFERENCE TO RELATED APPLICATIONS

This application is based upon and claims the benefit of priority from Japanese Patent Application No. 2005-129855, filed Apr. 27, 2005, the entire contents of which are incorporated herein by reference.

### BACKGROUND

1. Field

One embodiment of the invention relates to an optical head and an optical disc apparatus, which are devised to be able to read information from or write it to in any type of optical disc. In the present circumstances many kinds of optical disc have been developed.

2. Description of the Related Art

A digital versatile video disc (DVD) with a density higher than a conventional compact disc (CD) has been developed and is popular at present. A high density DVD (HD DVD) having higher density than a DVD will be developed in the future.

For reproducing information recorded on a CD, a red laser beam with a wavelength of approximately 785 nm is used to read the information. For reproducing information recorded on a DVD, a laser beam with a wavelength of approximately 655 nm is used to read the information. For reproducing information recorded in HD DVD, a laser beam with a wavelength of approximately 405 nm will be used to read the information.

As a laser beam wavelength is different according to a type of optical disc, it is necessary to prepare two or more laser beam sources (for wavelengths of 785, 655 and 405) for reproducing the above three types of optical disc in an information reproduce apparatus. It is also necessary to contrive the configuration of an optical head.

Examples of Japanese Patent Application Publication (KOKAI) Nos. 2004-14008, 2000-268397 and 11-339307 are known as an optical head having two or more light sources with their optical axes arranged on a common optical system.

However, in any of the Publications, light sources for laser beams with three wavelengths (785 nm, 655 nm and 405 nm) are not formed as a single unit. An idea of using light sources for laser beams with three wavelengths is not indicated in any publication.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical head apparatus in accordance with an embodiment of the invention;

FIG. 2 is an exemplary diagram showing an example of an essential part of the optical head shown in FIG. 1;

FIG. 3 is an exemplary diagram showing an example of another essential part of the optical head shown in FIG. 1;

FIGS. 4A and 4B are graphs each explaining an exemplary film characteristic inverting band (wavelength characteristic) of a wavelength selection film used for an optical head (PUH) of the optical disc apparatus shown in FIGS. 1 to 3; and

FIG. 5 is an exemplary diagram showing an example of an optical disc apparatus including an optical head (PUH) shown in FIG. 1, according to an embodiment of the invention.

### DETAILED DESCRIPTION

Various embodiments according to the invention will be described hereinafter with reference to the accompanying drawings. In general, according to one embodiment of the invention, an optical head including: a first light source which outputs a laser beam with a first wavelength; an object lens which condenses an input laser beam, emits the light to an optical disc, and receives a return laser beam reflected by the optical disc; a second light source which emits a laser beam with a second wavelength longer than the first wavelength; a first optical coupling prism which is placed on an optical axis between the first light source and object lens, and guides the laser beam with the second wavelength from the second light source to the object lens; a third light source which emits a laser beam with a third wavelength longer than the second wavelength; and a second optical coupling prism which is placed on an optical axis between the first optical coupling prism and object lens, and guides the laser beam with the third wavelength from the third light source to the object lens.

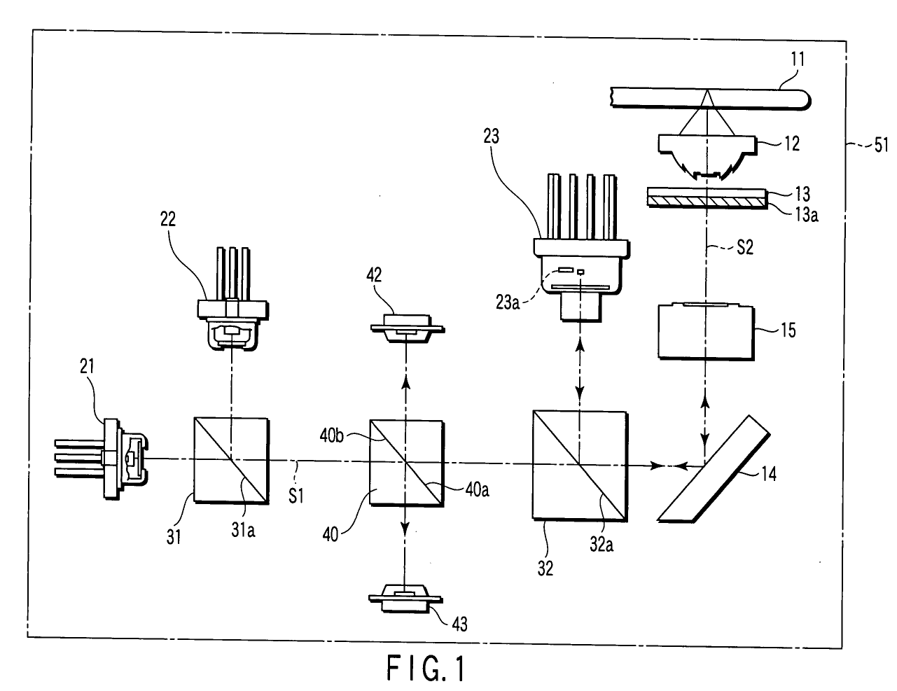

According to an embodiment, FIG. 1 shows an example of an optical head, to which the embodiments of the invention are applicable.

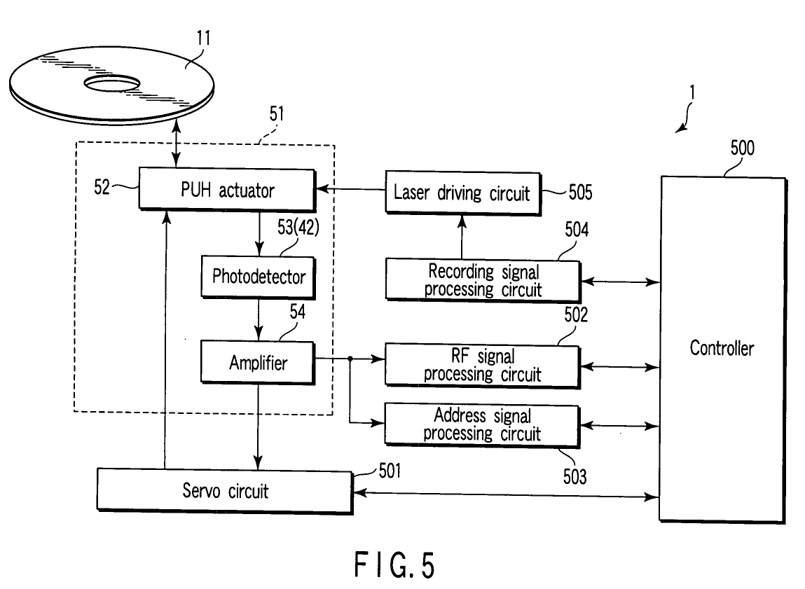

An optical disc apparatus 1 shown in FIG. 5 can record or reproduce information on/from an optical disc 11, by condensing a laser beam of predetermined wavelength explained hereinafter from an optical head 51 (including a PUH actuator 52) shown in FIG. 1, on an information recording layer of an optical disc 11 corresponding to an optional kind (standard) explained hereafter. The optical disc 11 is a disc of the CD or DVD standard, or HD (high density) DVD disc with the recording density increased to higher than the CD and DVD standards.

The PUH 52 can output any one of optical beams with first wavelength (405 nm), second wavelength (655 nm) and third wavelength (785 nm), according to the kind of a mounted optical disc 11, as explained in a later paragraph with reference to FIG. 1. The PUH 52 also detects a reflected laser beam reflected on a not-shown information-recording surface of the optical disk 11, and outputs an output signal usable for reproducing information already recorded.

The PUH 52 includes a first light source 21 that is a semiconductor laser element, for example. The wavelength of an optical beam emitted from the first light source 21 is 400 to 410 nm, preferably 405 nm. The PUH 52 also includes a second light source 22 that is a semiconductor laser element, for example. The wavelength of an optical beam emitted from the second light source 22 is preferably 655 nm.

The PUH 52 also includes a third light source 23 that is a semiconductor laser element, for example. The wavelength of an optical beam emitted from the third light source 23 is preferably 785 nm.

The laser beams from the first and second light sources are overlaid on the optical axis S1 by a polarization plane 31a of a first coupling prism 31. The laser beams emitted from the first and second light sources and traveling on the optical axis S1 are further overlaid by a half-mirror plane of a second optical coupling prism 32.

At a predetermined position of the PUH 52 opposite to the optical disc 11, an object lens 12 is provided. The object lens condenses the laser beam emitted from one of the first to third light sources 21 to 23 according to the kind of the optical disc 11, on a not-shown recording surface of the optical disc 11, and captures the reflected laser beam reflected on the recording surface.

The object lens 12 is a lens applicable to three wavelengths and capable of providing a predetermined numerical aperture (NA) for each laser beam output from the first to second laser elements 21 and 23. The object lens 12 is made of plastic, and has a numerical aperture NA of 0.65 for a laser beam with a wavelength of 405 nm, and 0.6 for a laser beam with a wavelength of 655 nm, for example.

The object lens 12 condenses a laser beam entered through the optical axis S2 of a light source, emits it to the optical disc 11, and receives a return laser beam reflected by the optical disc 11.

In the laser beam incident side of the object lens 12, a diffraction element and a λ/4 plate 13 are placed. A laser beam emitted from the first light source 21 is transmitted along the optical axis S1, reflected and changed in the traveling direction by a rising mirror 14, transmitted through a collimator lens 15 on the optical axis S2, transmitted through the diffraction element and λ/4 plate 13, and entered the object lens 12.

The optical axes S1 and S2 may be arranged on a straight line. In this case, the rising mirror 14 is unnecessary. The optical axis S2 is shown as extending parallel to the third laser beam source 23 in FIG. 1, but actually it extends vertically to the surface of paper.

A second laser beam emitted from the second light source 22 enters the first optical coupling prism 31 placed on the optical axis S1 between the first laser beam source 21 and the rising mirror 14. The first optical coupling prism 31 reflects the second laser beam on the surface of a wavelength selection film 31a, aligns with the optical axis S1, and advances to the rising mirror 14 (object lens 12).

A third laser beam emitted from the third light source 23 enters the second optical coupling prism 32 placed on the optical axis S1 between the first optical coupling prism 31 and the rising mirror 14. The second optical coupling prism 32 reflects the third laser beam on the surface of a wavelength selection film (half-mirror) 32a, aligns with the optical axis S1, and advances to the rising mirror 14 (object lens 12).

The return laser beam reflected by the optical disc 11 is returned through the object lens 12, diffraction element and λ/4 plate 13, collimator lens 15, and rising mirror 14.

If the third laser beam source 23 is used, the return laser beam is sent from the rising mirror 14 to the second optical coupling prism 32, reflected on the surface of the wavelength selection film 32 of the second optical coupling prism 32, and sent to and received by a light-receiving unit 23a provided integrally with the third laser beam source 23.

The collimator lens 15 controls a spread angle, so that the laser beams from the laser beam sources 21, 22 and 23 are stably input to the object lens 12.

In the diffraction element and λ/4 plate 13, the λ/4 plate 13 polarizes a traveling laser beam circularly. Further, in the diffraction element and λ/4 plate 13, the λ/4 plate 13 changes the polarization direction of the return laser beam based on the first and second laser beam sources 21 and 22, to S-polarized. After the polarization direction of the plane of polarization is changed to S-polarized, the reflected laser beam is divided in its area.

Explanation will now be given on the return laser beam when the second laser beam source 22 is used. The return laser beam reflected by the optical disc 11 is input to a beam splitter 40 through the object lens 12, diffraction element and λ/4 plate 13, collimator lens 15, rising mirror 14 and second optical coupling prism 32. The return laser beam entered the beam splitter 40 is reflected by the wavelength selection film 40a, and input to a main light-receiving unit (photodetector) 42. The main light-receiving unit 42 receives the return laser beam at the center of a 4-divided photodiode, for example. The output of the photodiode is amplified, and synthesized as a high frequency reproducing signal H. After being amplified, the output of the photodiode is input to a signal processing unit in which subtraction and addition processing are combined. The signal processing unit can detect a tracking error signal and a focus error signal.

Now, explanation will be given on the return laser beam when the third laser beam source 23 is used. The return laser beam is led to a main light-receiving unit 42, as when the second laser beam source 22 is used.

The beam splitter 40 can lead a part of a traveling laser beam (a laser beam from the first optical coupling prism 31 to the second optical coupling prism 32) to a light-receiving unit 43 for automatic power control, as well as leading the return laser beam to the main light-receiving unit 42 as described above. The wavelength selection film 40a of the beam splitter 40 is used also as a mirror 40b for dividing a traveling laser beam at a predetermined ratio. Namely, the laser beams from the first and second laser beam sources 21 and 22 are partially reflected on the surface of the wavelength selection film 40b of the beam splitter 40, and input to the light-receiving unit 43 for automatic power control. A change in the intensity of the laser beam detected by the light-receiving unit 43 is selectively input to a gain control circuit of the first and second laser beam sources 21 and 22, to stabilize the laser beam output to a preset power.

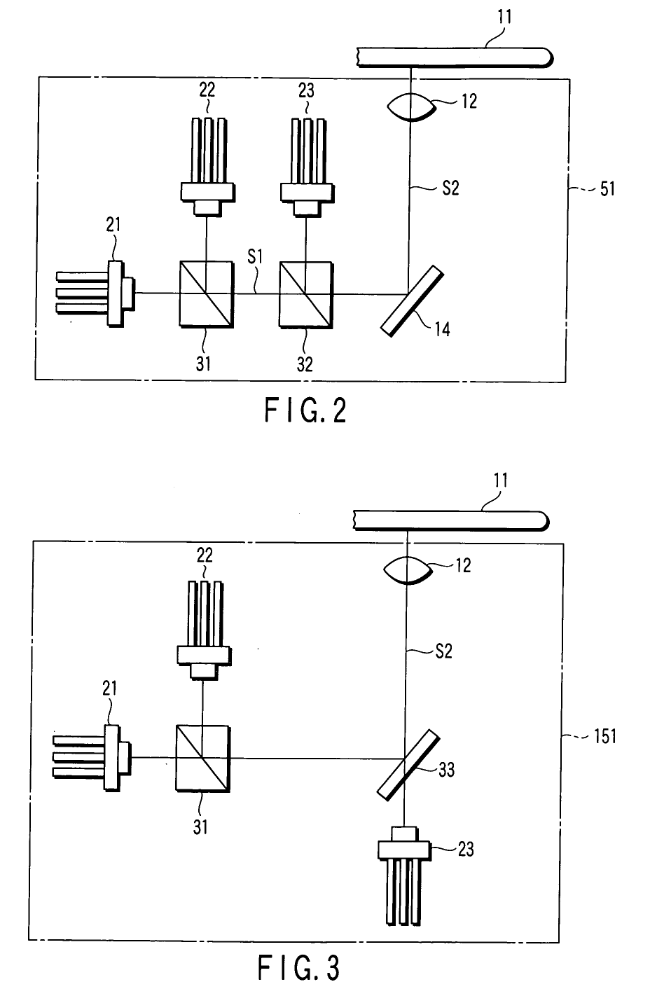

FIG. 2 shows the extracted characteristic part of the invention applied to the optical head (PUH) of FIG. 1. The same components as in FIG. 1 are given the same reference number.

The PUH 51 shown in FIG. 2 is characterized by the arrangement that the number of reflections is decreased to the least for a laser beam emitted from the first laser beam source 21 which outputs a laser beam with a short wavelength. A laser beam from the first laser beam source 21 is reflected only once by the rising mirror 14 until reaching the optical disc 11. Laser beams from the second and third laser beam sources 22 and 23 are reflected twice until reaching the optical disc 11.

This also means that the first laser beam source 21 corresponding to a larger number of numerical aperture (NA) of lens is preferentially arranged, and designed to reach a disc with less number of reflections. Because, when a wavelength is short and a numerical aperture is many, strict design is requested.

Namely, as a sequence of synthesizing a laser beam on the optical axis S1 of the first laser beam (wavelength of 405 nm), a dichroic prism is used to synthesize the second laser beam (wavelength of 655 nm). The unit is designed so that the third laser beam (wavelength of 785 nm) is further synthesized with respect to the optical axis S1 after a synthesizer.

FIG. 3 shows an example of the third laser beam source 23 arranged on an extension line of the optical axis S2. The same components as in FIG. 2 are given the same reference numerals. In the arrangement of the third laser beam source 23 shown in FIG. 3, the rising mirror 33 is given only a function as a half-mirror compared with the rising mirror (14) shown in FIGS. 1 and 2, and can transmit a laser beam with an wavelength of 785 nm emitted from the third laser beam source 23.

In the arrangement of the laser element of PUH 151 shown in FIG. 3, the second optical coupling prism 32 does not exist in the optical paths of the laser beams from the first and second laser beam sources 21 and 22, and the light use efficiency can be increased.

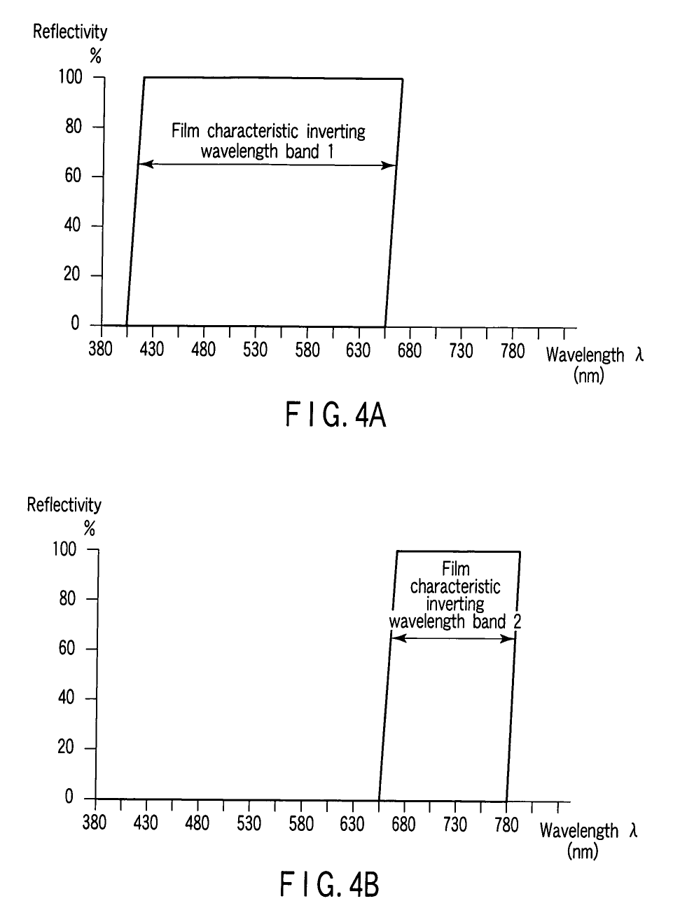

FIGS. 4A and 4B show examples of film characteristic inverting characteristics demanded for a film characteristic inverting wavelength band of the wavelength selection films of the first and second optical coupling prisms 31 and 32.

FIG. 4A shows an example of the characteristic of the wavelength selection film 31a of the first optical coupling prism 31 (dichroic prism). FIG. 4B shows an example of the characteristic of the wavelength selection film 32a of the second optical coupling prism 32 (trichroic prism). In FIGS. 4A and 4B, the vertical axis indicates a reflectivity (%), and the horizontal axis indicates a wavelength. Therefore, when calculating a transmissivity (%), follow the equation, transmissivity (%)=(100−reflectivity (%)). The film inverting wavelength mentioned here means a wavelength band to invert the characteristic of reflection.

In FIG. 4A, the film characteristic inverting wavelength band 1 is set preferably to 405 to 655 nm, as explained with reference to FIGS. 1 to 3. As shown in FIG. 4B, the wavelength characteristic of the film characteristic inverting wavelength band 2 is defined to 655 to 785 nm, as explained with reference to FIGS. 1 to 3.

It is known that a wavelength of a laser beam output from a laser element is usually fluctuated by 10 nm/5° C., for example, by fluctuations in the temperature of a laser element and ambient temperature. A central wavelength of an output laser beam is different by individuals. Of course, a wavelength of a laser beam output from a laser element to output a laser beam with a wavelength of 785 nm is also fluctuated by fluctuations in the temperature of a laser element and ambient temperature. A central wavelength of an output laser beam is different by individuals. Therefore, actually, a wavelength area of film characteristic inverting wavelength band is of course defined including the influence of the temperature fluctuations.

FIG. 5 is a block diagram of the configuration of the optical disc unit according to the invention. A laser beam emitted from the optical head (PUH actuator) 52 is condensed on the information recording layer of the optical disc 11, information is recorded on the optical disc 11, and the recorded information can be reproduced from the optical disc 11. The block enclosed by a broken line corresponds to the optical head explained in FIG. 1.

A laser beam reflected by the optical disc 11 is detected as an electric signal by a photodetector (PD) 53 of PUH 52 (the photodetector 42 in FIG. 1). The output signal of the PD 53 is amplified by the amplifier 54, and output to a servo circuit (lens position control unit) 501, a RF signal processing circuit (output signal processing circuit) 502 and an address signal processing circuit 504, which are connected to the controller 500 (lens position control amount setting unit (main controller)).

The servo circuit 501 generates a focus servo signal (to control the difference in the distance between a recording layer of the optical disc 11 and an object lens, with respect to the focal position of an object lens) for an object lens (12) of the PUH 52, and a tracking servo signal (to control the position of an object lens in the direction of crossing the track of the optical disc 11). These signals are output to a not-shown focus actuator and tracking actuator (lens position control mechanism), respectively.

The RF signal processing circuit 502 takes out user data and management information from a signal detected and reproduced by the PD 53. The address signal processing circuit 503 takes out address information, that is, information indicating a track or sector of the optical disc 11 opposed now to the object lens (12) of the PUH 52. The taken-out information is output to the controller 500.

The controller 500 executes data processing to read data such as user data at a desired position, or to record user data and management information at a desired position, based on the address information. The controller also generates a control signal to control the position of PUH 52.

The controller 500 instructs an optical intensity of a laser beam to be output from first to third laser elements 21 to 23 when recording or reproducing information on/from the optical disc 11. According to the instruction of the controller 500, the data recorded at an address of a desired position (track or sector) can be erased.

When recording information on the optical disc, (under the control of the controller 500) a recording signal processing circuit 504 supplies the laser driving circuit (LDD) 505 with a recording data, or a recording signal modulated to a recording waveform signal suitable for recording on the optical disc. Therefore, the laser element of the PUH 52 emits a laser beam with the intensity changed according to recording information, corresponding to a laser driving signal output from the LDD (laser driving circuit) 121. Information is recorded on the optical disc 11 by this.

As explained hereinbefore, according to an embodiment of the optical head of the invention, a high grade apparatus can be easily designed by arranging a laser beam source for emitting a laser beam with a short wavelength to decrease the number of reflections to the least. Concretely, in this example, a light source with a shortest wavelength is arranged at a position farthest from an object lens.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head comprising:
a first light source which outputs a laser beam with a first wavelength;
an object lens which condenses an input laser beam, emits the light to an optical disc, and receives a return laser beam reflected by the optical disc;
a second light source which emits a laser beam with a second wavelength longer than the first wavelength;
a first optical coupling prism which is placed on an optical axis between the first light source and object lens, and guides the laser beam with the second wavelength from the second light source to the object lens;
a third light source which emits a laser beam with a third wavelength longer than the second wavelength; and
a second optical coupling prism which is placed on an optical axis between the first optical coupling prism and object lens, and guides the laser beam with the third wavelength from the third light source to the object lens.

2. The optical head according to claim 1, further comprising:
a beam splitter which is placed on an optical axis between the first and second optical couplings prisms, and branches the return laser beam returned through the object lens before the first optical coupling prism; and
a light-receiving unit which outputs an electric signal corresponding to the amount of light of the return laser beam branched from the beam splitter.

3. The optical head according to claim 2, further comprising a light-receiving unit for automatic power control, which outputs an electric signal corresponding to the amount of light of a traveling laser beam branched from the beam splitter to refer to the output of the first or second light sources,
wherein the beam splitter is configured to ranch a part of a laser beam traveling from the first optical coupling prism to the second optical coupling prism, and directs the branched traveling laser beam to the light-receiving element for automatic power control.

4. The optical head according to claim 1, wherein the first optical coupling prism has a reflection film with a wavelength band area of 405-655 nm of a film characteristic inverting wavelength band.

5. The optical head according to claim 1, wherein the second optical coupling prism has a reflection film with a wavelength band area of 655-785 nm of a film characteristic inverting wavelength band.

6. The optical head according to claim 4, further comprising:
a beam splitter which is placed on an optical axis between the first and second optical couplings prisms, and branches the return laser beam returned through the object lens before the first optical coupling prism; and
a light-receiving unit which outputs an electric signal corresponding to the amount of light of the return laser beam branched from the beam splitter.

7. The optical head according to claim 6, further comprising a light-receiving unit for automatic power control, which outputs an electric signal corresponding to the amount of light of a traveling laser beam branched from the beam splitter to refer to the output of the first or second light sources,
wherein the beam splitter is configured to ranch a part of a laser beam traveling from the first optical coupling prism to the second optical coupling prism, and directs the branched traveling laser beam to the light-receiving element for automatic power control.

8. The optical head according to claim 5, further comprising a beam splitter which is placed on an optical axis between the first and second optical couplings prisms, and branches the return laser beam from the object lens before the first optical coupling prism; and
a light-receiving unit which outputs an electric signal corresponding to the amount of light of the return laser beam branched from the beam splitter.

9. The optical head according to claim 8, further comprising a light-receiving unit for automatic power control, which outputs an electric signal corresponding to the amount of light of a traveling laser beam branched from the beam splitter to refer to the output of the first or second light sources,
wherein the beam splitter is configured to ranch a part of a laser beam traveling from the first optical coupling prism to the second optical coupling prism, and directs the branched traveling laser beam to the light-receiving element for automatic power control.

10. The optical disc unit comprising:
an optical head unit;
a light-receiving unit which outputs an electric signal corresponding to the amount of light of a return laser beam obtained through the object lens; and
a signal reproducing circuit which processes an output signal from the light-receiving unit.

11. The optical disc unit according to claim 10, further comprising a beam splitter which is placed on an optical axis between the first and second optical couplings prisms, and branches the return laser beam from returned through the object lens before the first optical coupling prism.

12. The optical disc unit according to claim 11, further comprising a light-receiving unit for automatic power control, which outputs an electric signal corresponding to the amount of light of a traveling laser beam branched from the beam splitter to refer to the output of the first or second light sources,
wherein the beam splitter is configured to ranch a part of a laser beam traveling from the first optical coupling prism to the second optical coupling prism, and directs the branched traveling laser beam to the light-receiving element for automatic power control.

13. An optical pickup head unit comprising:
an object lens which captures a laser beam reflected by the recording layer of a recording medium;
a first light source which outputs a laser beam with a first wavelength guided to the object lens passing through all film characteristic inverting wavelength band provided in a space to the object lens;
a second light source which outputs a laser beam with a second wavelength longer than the wavelength of the first wavelength, reflected by at least one of the film characteristic inverting wavelength band provided in a space to the object lens, and guided to the object lens; and
a third light source which outputs a laser beam with a third wavelength longer than the first and second wavelengths, guided to the object lens without passing through the film characteristic inverting wavelength band provided in a space to the object lens.
